(19) United States
(12) Patent Application Publication
(10) Pub. No.: US 2008/0118081 A1
(43) Pub. Date: May 22, 2008

(54) Method and Apparatus for Canceling a User's Voice

(76) Inventor: William Michael Chang, Chicago, IL (US)

Correspondence Address: William Chang, 4853 N. Winthrop Ave. Apt 3S, Chicago, IL, 60640, US

(21) Appl. No.: 11/561,102

(22) Filed: Nov. 17, 2006

(51) Int. Cl. H04B 15/00

(52) U.S. Cl. 381/94.1

(57) ABSTRACT

The disclosed system is designed to provide active noise cancellation to a user of an electronic device, such as a cellular device. For example, the system allows the user's voice to be transmitted via a cellular network, while at the same time canceling the user's voice externally. As a result, the system provides a user with a measure of privacy. The system may filter ambient noise before transmitting the user's voice. In addition, the system may store characteristics of a user's voice in order to better perform voice cancellation.

### BACKGROUND

Noise cancellation technologies have been developed to cancel sounds. There are two types of noise cancellation technologies, active and passive noise cancellation. Passive noise cancellation involves blocking out sound waves before they enter the ear. For example, machinery operators often use headphones to block out the sound of heavy machinery. Active noise cancellation involves using sound waves out of phase to cancel each other out.

Cellular phone devices have become more common in every day use. Cellular phone users commonly use the devices in public places. Due to the nature of cellular phones, users often find it difficult to gauge how loudly they must speak into their devices. As a result, public spaces are often filled with the sounds of people speaking loudly into their cellular devices. This can be problematic for people in those public spaces.

In addition, a cellular phone user may need to discuss private information in a public space. While users will speak in a lower voice, cellular technology often requires them to speak louder in order to be heard. The user would prefer to keep the information private, but necessity forces them to disclose the information publicly.

Active noise cancellation has mostly been confined to headphones that remove external sounds. While using active noise cancellation in headphones allows the headphone user to filter out external sounds, it does little for those without headphones. Active noise cancellation headphones also do not provide the speaker any additional privacy.

### SUMMARY

The disclosed system is designed to provide active noise cancellation to a user of an electronic device, such as a cellular device. For example, the system allows the user's voice to be transmitted via a cellular network, while at the same time canceling the user's voice externally. As a result, the system provides a user with a measure of privacy.

The system may filter ambient noise before transmitting the user's voice. In addition, the system may store characteristics of a user's voice in order to better perform voice cancellation.

Additional features and advantages are described herein, and will be apparent from, the following Detailed Description and the figures.

### BRIEF DESCRIPTION OF THE FIGURES

FIG. 1 is a block diagram showing an example user sound wave interacting with an example voice canceling apparatus.

FIG. 2 is another block diagram showing an example user sound wave interacting with an example voice canceling apparatus.

FIG. 3 is a block diagram showing an example of a voice canceling apparatus from a front view.

FIG. 4 is a block diagram showing an example of a voice canceling apparatus from a back view.

FIG. 5 is a block diagram of an example voice canceling device.

FIG. 6 is a flowchart of an example process to cancel a voice sound.

### DETAILED DESCRIPTION

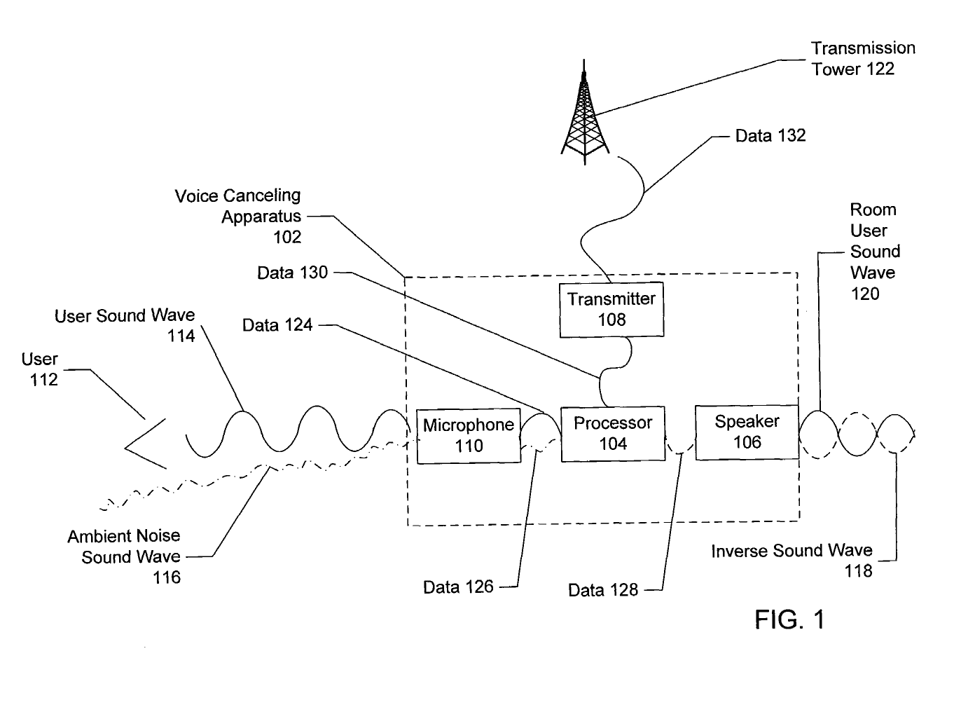

A high level block diagram depicting an example voice sound interacting with an example voice canceling apparatus is shown in FIG. 1. In this example, a user 112 creates a user sound wave 114. For example, the user 112 could speak, or create a sound using a sound creating device such as a radio. The user 112 could be a single person or more than one person. The user sound wave 114 reaches the voice canceling apparatus 102 at a microphone 110. The voice canceling apparatus 102 can be any suitable electronic device, such as a cellular phone, personal digital assistant (PDA), microphone device, etc.

In this example, there is one microphone 110. In another example, there are multiple microphones in order to determine an angle associated with a path of travel of the user sound wave 114. For example, by using more than one microphone 110, the voice canceling apparatus 102 can better calculate the angle at which the user sound wave 114 enters the voice canceling apparatus 102. This would enable the apparatus 102 to emit an inverse sound wave 118 more closely out of phase with a room user sound wave 120.

In this example, the microphone 110 receives an ambient noise sound wave 116 in addition to the user sound wave 114. The ambient noise sound wave 116 may be generated by other speakers in the area of the user 112, sound of devices in the area of the user 112, and/or by other sources generating sounds that the user 112 does not wish to transmit to a transmission tower 122. In another example, the ambient noise sound wave 116 includes the inverse sound wave 118 emitted by the speaker 106. The microphone 110 may receive the inverse sound wave 118, and the user 112 may not want the inverse sound wave 118 to be transmitted to the transmission tower 122.

In this example, microphone 110 sends data 124 indicative of the user sound wave 114, and data 126 indicative of the ambient noise sound wave 116 to the processor 104. For example, the microphone 110 or a circuit connected to the microphone 110 may contain circuitry to digitize a sound wave into a digital representation.

In this example, the processor 104 is configured to determine and transmit data 128 indicative of the inverse sound wave to the speaker 106. The processor 104 determines the data 128 indicative of the inverse sound wave 118 so that the voice canceling apparatus 102 can cancel the room user sound wave 120. Through deconstructive interference, an inverse sound wave 118, or a sound wave out of phase with another, will cancel the original sound wave, producing little or no sound at all.

The processor 104 also filters the data 126 indicative of the ambient noise 116. For example, by performing an analysis, the processor 104 can determine the data 126 indicative of the ambient noise and remove it from the overall data 130. In another example, the processor 104 is configured to store data 128 indicative of the inverse sound wave 118 and remove the data 128 from the overall data 130 before sending the data 130 to the transmitter 108.

The processor 104 also transmits data 130 indicative of the user sound wave to the transmitter 108. In the example the transmitter 108 transmits data 132 indicative of the user sound wave to a transmission tower 122. In the present example, the transmission tower 122 transmits the data 132 indicative of the user sound wave 114 via a cellular network.

The speaker 106 receives data 128 indicative of the inverse sound wave 118 from the processor 104. In the example, the speaker 106 emits an inverse sound wave 118 into a room to cancel the room user sound wave 120. The room user sound wave 120 is representative of the user sound wave 114 in the area of the user 112 and is not also emitted by the speaker 106.

In the current example, there is only one speaker 106. However, in other examples, multiple speakers are used to emit the inverse sound wave 118 at angles determined to best emit the inverse sound wave 118 entirely out of phase with the room user sound wave 120. Additionally, in another example, the speaker 106 receives data 128 indicative of the inverse sound wave and other sound waves. The speaker 106 in the example would emit all of the sound waves. The other sound waves could be sounds that the user wishes to be emitted in order to afford greater privacy. For example, the other sound waves may be static, white noise, etc.

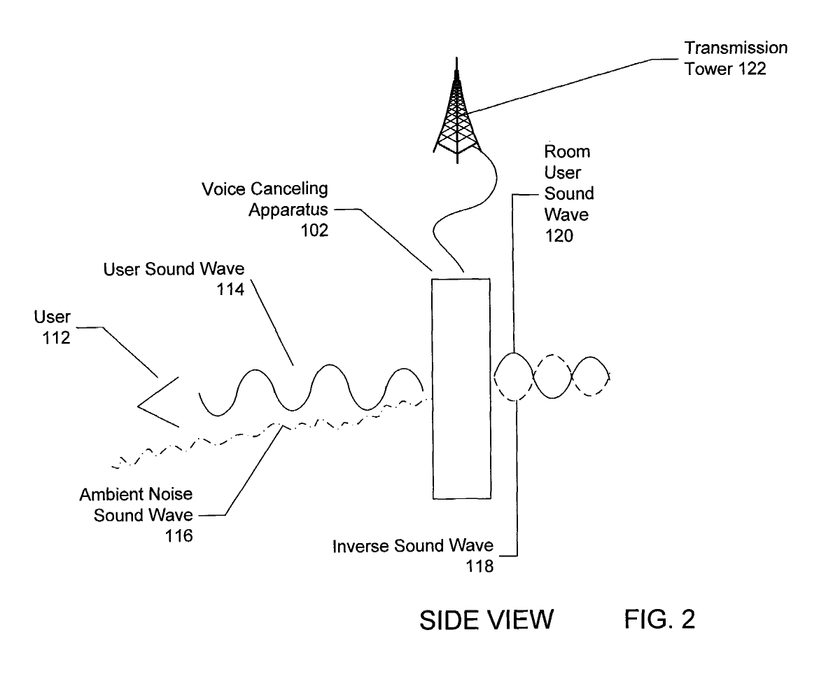

A block diagram depicting aside view of an example voice canceling apparatus 102 is show in FIG. 2. Additionally, in other examples not all of the elements such as the microphone 110 or the speaker 106 etc, are in a single device.

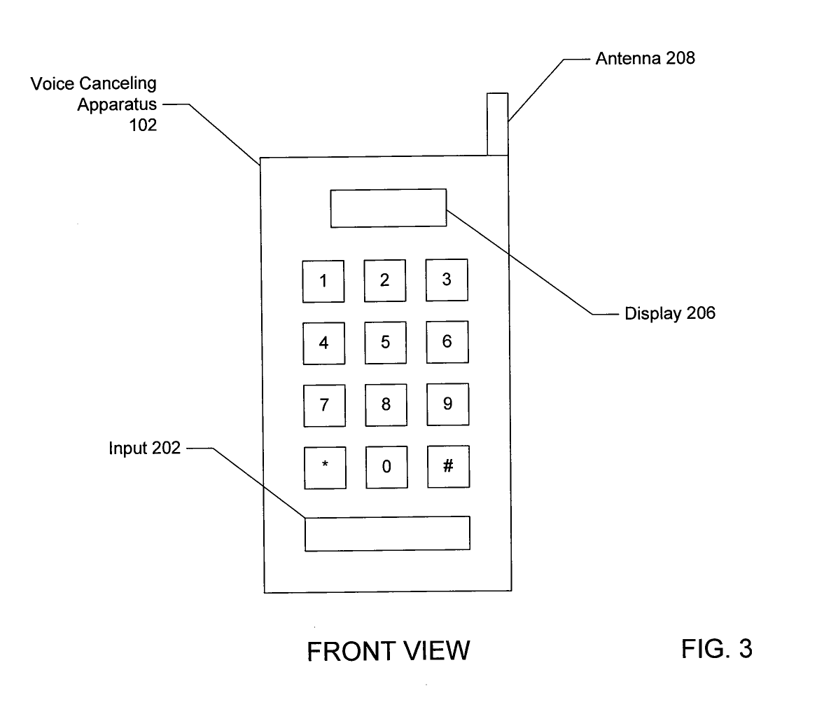

A block diagram depicting a front view of a voice canceling apparatus 102 is shown in FIG. 3. In one example, the voice canceling apparatus 102 includes an input 202. The input 202 could be a microphone 110 or another input device. In another example, the voice canceling apparatus 102 includes a plurality of microphones to better determine a direction that the sound wave is entering the voice canceling apparatus 102. In that example, the voice canceling apparatus 102 may use the direction that a sound wave is entering the voice canceling apparatus 102 to determine an angle at which an inverse sound wave 118 should be emitted. In one example, the voice canceling apparatus 102 includes features associated with a typical cellular phone device or PDA, such as a keypad 204, display 206, antennae 208, etc. It should be noted that the included features may not appear in all examples, for instance the antenna 208 may be internal to the device 102 or not present at all.

In another example, the input 202 is separate from the body of the voice canceling apparatus 102. For example, the input 202 can be connected to the voice canceling apparatus 102 via a cable or via a wireless connection such as Bluetooth technology or similar technology etc.

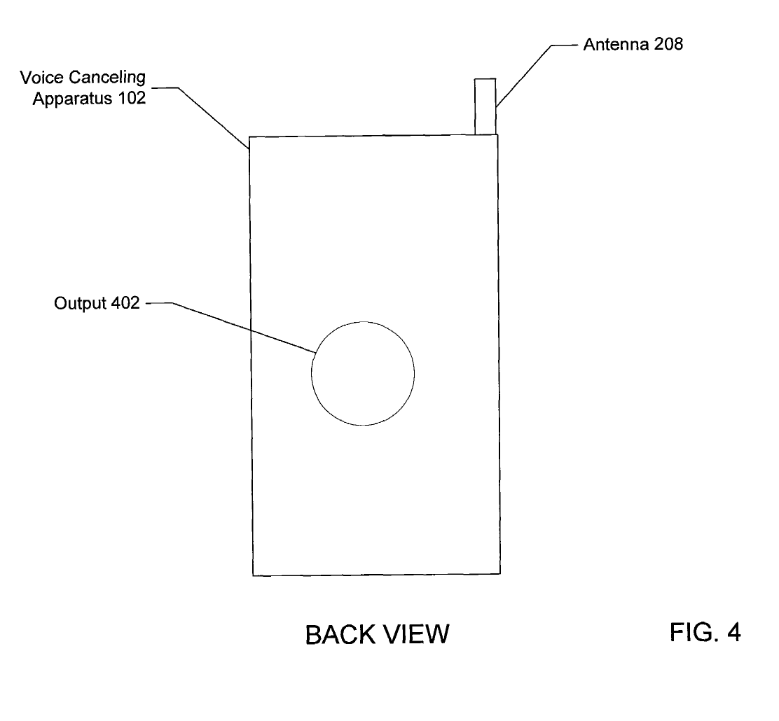

A block diagram depicting an example of the back view of a voice canceling apparatus 102 is shown in FIG. 4. In one example, the voice canceling apparatus 102 includes an output 402. The output 402 may be a speaker, or another sound emitting element. In another example, the voice canceling apparatus 102, includes a plurality of outputs. In another example, the output is a speaker that is adapted to emit sounds at specific angles designed to ensure that an inverse sound wave is out of phase with a room user sound wave 120. It should be understood that the speaker 402 can be located in any location on the voice canceling apparatus 102, or the speaker 402 may be located separately from the voice canceling apparatus 102.

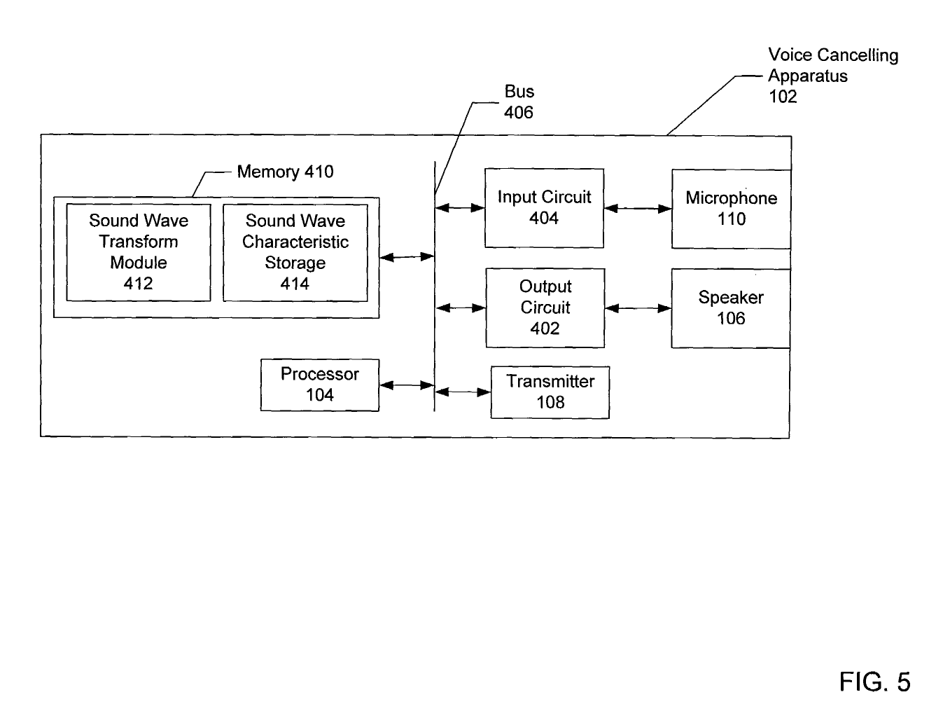

A block diagram of an example voice canceling apparatus 102 is shown in FIG. 5. In one example, the voice canceling apparatus 102 includes one or more processors 104 electrically coupled with a bus 406 to a transmitter 108, input circuit 404, output circuit 402, and memory 410. In the example, the memory 410 contains modules that facilitate performing transformations on the sound wave 412, and storing characteristics of the sound wave 414. The voice canceling apparatus 402 stores characteristics of the user sound wave 114 in order to facilitate determination of the inverse sound wave 118, and removal of the inverse sound wave 118 before transmission.

The input circuit 404 is connected to the microphone 110, and performs conversion of the user sound wave 114 into data 124. The input circuit 404 may control the manner in which the audio user sound wave 114 is digitized into data 124 and data 126. The output circuit 402 is connected to the speaker 106, and performs translation of the data 128 indicative of the inverse sound wave to an audio inverse sound wave 118.

In another example, the voice canceling apparatus 402 stores characteristics of the user sound wave 114 in order to perform additional functions such as voice dialing, phone security, etc. In the example, the module 412 contains sub-modules that remove ambient sound from the user sound wave 114, and aids the processor 104 in determining the data 128 indicative of the inverse sound wave 118. In one example, ambient sound can include the emitted sound wave indicative of the inverse of the user sound wave 114. In one embodiment the processor 104 receives data from the input circuit 404, and sends data to the output circuit 402 as well as the transmitter 108.

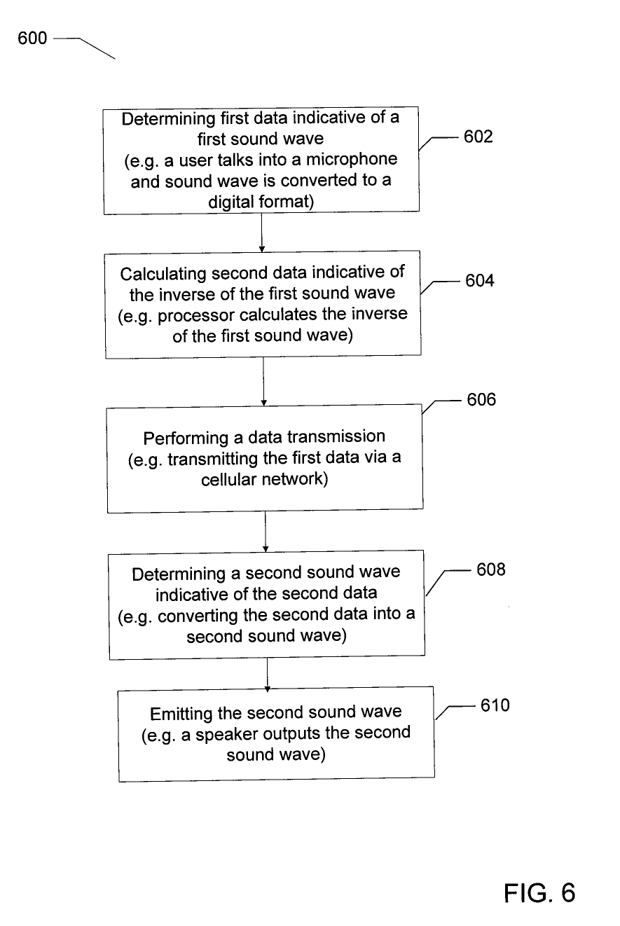

A flowchart of an example process 600 to cancel a user sound wave 114 is depicted in FIG. 6. Although the process 600 is described with reference to the flowchart illustrated in FIG. 6, it will be appreciated that many other methods of performing the acts associated with process 600 may be used. For example, the order of many of the steps may be changed, and some of the steps described may be optional.

In this example, the process 600 determines first data indicative of a first user sound wave 114 (block 602). For example, a user 112 could speak into the apparatus' 102 microphone 110 which transmits a signal to the input circuit 404, which digitizes the sound wave and transmits that data 124 and 126 to the processor 104. The input circuit 404 then sends the signal, via an internal bus 406 to the processor 408. Alternatively, the apparatus 102 could receive the digital data 124 and 126 from another external source.

The process calculates second data indicative of the inverse of the sound wave 114 (block 604). For example, the processor 104, using modules contained in the memory 410, calculates the inverse of the first sound wave 114 to create an inverse sound wave 128. In another example, the processor 104 performs transformations to the data to represent amplifying the sound wave or decreasing the amplitude of the sound wave. The processor 104 performs the transformations to better match the room user sound wave 120. In yet another example, the processor 104 performs other calculations to the data 124 and 126 to represent angle of entry, or shifts in time of the sound wave 114, to better match the room user sound wave 120.

The process performs a data transmission (block 606). For example, the first data indicative of a user sound wave is sent from the processor 104 to the transmitter 108 and then transmitted via a cellular network. In one example, the processor filters ambient noise 126 from the first data 124 indicative of the user sound wave 114 before transmission. The ambient noise 126 can include other sound waves such as sound waves emitted from the apparatus 102 itself, such as the inverse sound wave 118.

The process also determines a second sound wave indicative of the second data (block 608). For example, the processor 104 can send the second data 128 to the output circuit 402 which then converts the second data 128 indicative of the inverse sound wave 118 into an audio inverse sound wave 118.

The process emits the sound wave (step 610). For example, the processor 104 can send a signal 128 to the output circuit 402, causing the output circuit to output the sound wave 118 via a speaker 106. In one example, the output inverse sound wave 118 is emitted out of phase with the room user sound wave 120.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of canceling a first sound wave indicative of a voice, the method comprising:
receiving the first sound wave via a microphone, the first sound wave indicative of a user's voice;
determining first data indicative of the first sound wave;
calculating second data indicative of an inverse of the first sound wave;
performing a data transmission via a wireless phone network, the data transmission including first transmission data indicative of the first sound wave;
determining a second sound wave indicative of the second data; and
emitting the second sound wave via a speaker.

2. The method of claim 1, including:
determining third data indicative of the second sound wave; and
performing a calculation that removes the third data from the first data to determine the first transmission data;

3. The method of claim 1, wherein determining the first data includes filtering data indicative of an ambient sound wave.

4. The method of claim 1, wherein calculating the second data indicative of the inverse of the first sound wave includes calculating the second data to be indicative of increasing the amplitude of an inverse of the first sound wave.

5. The method of claim 1, wherein calculating the second data indicative of the inverse of the first sound wave includes calculating the second data to be indicative of decreasing the amplitude of an inverse of the first sound wave.

6. The method of claim 1, wherein emitting the second sound wave includes emitting the second sound wave in a first direction opposite from a second direction associated with the first sound wave.

7. The method of claim 1, including storing a characteristic of the first sound wave, the characteristic including an average amplitude.

8. The method of claim 7, wherein calculating the second data indicative of the inverse of the first sound wave includes calculating the second data using the characteristic.

9. The method of claim 1, wherein the second sound wave is indicative of the second data and is indicative of third data indicative of a third sound wave, where the third sound wave is designed to interfere with the first sound wave.

10. The method of claim 9, wherein the third sound wave is white noise.

11. An apparatus for canceling a first sound wave indicative of a voice, said apparatus comprising:
an input sensor to receive a first sound wave;
a processor for calculating first data indicative of the first sound wave;
the processor for calculating second data indicative of an inverse of the first sound wave;
a processor for calculating third data indicative of the first data;
a speaker for emitting a second sound wave indicative of the second data; and
a transmitter for transmitting the third data indicative of the first data.

12. The apparatus of claim 11, wherein the processor is structured to remove the second data indicative of an inverse of the first sound wave from the first data indicative of first sound wave to determine the third data indicative of the first data.

13. The apparatus of claim 11, wherein the input sensor is structured to determine a first direction associated with the first sound wave.

14. The apparatus of claim 13, wherein the speaker is located to output the second sound wave at a second direction opposite from the first direction associated with the first sound wave.

15. The apparatus of claim 11, wherein the transmitter transmits to a wireless network.

16. The apparatus of claim 11, wherein the speaker includes a plurality of speakers.

17. The apparatus of claim 11, wherein the input sensor includes the speaker.

18. The apparatus of claim 11, wherein the input sensor is a microphone.

19. A method of canceling a first sound wave indicative of a voice, the method comprising:
receiving the first sound wave;
determining first data indicative of the first sound wave;
calculating second data indicative of an inverse of the first sound wave;
performing a data transmission, the data transmission including first transmission data indicative of the first sound wave;
determining a second sound wave indicative of the second data; and
emitting the second sound wave.

20. The method of claim 19, wherein performing the data transmission includes performing the data transmission via a wireless data network.
